(19) United States
(12) Patent Application Publication
(10) Pub. No.: US 2016/0072606 A1
(43) Pub. Date: Mar. 10, 2016

(54) DEVICE AND METHOD FOR DETECTING GUARD INTERVAL OF ORTHOGONAL FREQUENCY DIVISION MULTIPLEXING SIGNAL

(71) Applicant: Novatek Microelectronics Corp., Hsinchu (TW)

(72) Inventors: Yuan-Hsin Chuang, Kaohsiung County (TW); Chung-Hsien Hsieh, Hsinchu County (TW)

(21) Appl. No.: 14/534,179

(22) Filed: Nov. 6, 2014

(30) Foreign Application Priority Data
Sep. 9, 2014 (TW) 103130988

(51) Int. Cl. H04J 11/00; H04W 24/08

(52) U.S. Cl. CPC H04J 11/0023; H04W 24/08

(57) ABSTRACT

A device and a method for detecting a guard interval (GI) of an orthogonal frequency division multiplexing (OFDM) signal are provided. The device includes a signal transforming unit and a GI determining unit. The signal transforming unit receives the OFDM signal and sets a predetermination GI to provide a first frequency-domain symbol and a second frequency-domain symbol. The GI determining unit receives the predetermination GI, the first frequency-domain symbol and the second frequency-domain symbol to determine a phase difference between the first frequency-domain symbol and the second frequency-domain symbol and determines the GI of the OFDM signal according to the phase difference.

### CROSS-REFERENCE TO RELATED APPLICATION

This application claims the priority benefit of Taiwan application serial no. 103130988, filed on Sep. 9, 2014. The entirety of the above-mentioned patent application is hereby incorporated by reference herein and made a part of this specification.

### BACKGROUND OF THE INVENTION

1. Field of the Invention

The invention relates to a detecting device and a detecting method, and particularly relates to a device for detecting a guard interval of an orthogonal frequency division multiplexing signal and a method thereof.

2. Description of Related Art

As the communication technology continuously improves, it has now been the trend to aim at carrying more and more data bits with a limited bandwidth. To use the spectrum more effectively, various multi-carrier communication technologies, such as the technologies of frequency division multiplexing (FDM) and orthogonal frequency division multiplexing (OFDM), etc., have been developed. Taking the OFDM technology for example, it mainly divides a limited bandwidth into a plurality of sub-channels, and using a plurality of sub-carriers for transmission in parallel. Meanwhile, the orthogonality is maintained among the sub-carriers, and through different modulation, different sub-carriers may carry different data bits respectively.

In the OFDM technology, a guard interval (GI), such as a cyclic prefix (CP), may be set between symbols when forming an orthogonal frequency division multiplexing signal, so as to prevent inter-symbol interference (ISI) and inter-carrier interference (ICI). In a communication system using the OFDM technology, one or more guard intervals with fixed lengths are specified in the specification, such that the guard intervals with different lengths may be used in correspondence with different environments. However, an inappropriate choice on the length of the guard interval may directly influence the data transmission efficiency.

In the conventional method for detecting the guard interval, amplitudes of the orthogonal frequency division multiplexing signal are accumulated continually for each of guard interval settings, so as to determine the correct guard interval. However, such detection method requires a longer time for calculation, and is only applicable to the guard intervals of specific types. In addition, the orthogonal frequency division multiplexing signal in the time domain still has the issues of ISI and ICI, so the judgment on the guard interval may still be influenced.

### SUMMARY OF THE INVENTION

The invention provides a device for detecting a guard interval of an orthogonal frequency division multiplexing signal and a method thereof capable of preventing inter-symbol interference and inter-carrier interference and able to quickly and accurately determine the guard interval of the orthogonal frequency division multiplexing signal.

The device for detecting the guard interval of the orthogonal frequency division multiplexing signal of the invention includes a signal transforming unit and a guard interval determining unit. The signal transforming unit receives the orthogonal frequency division multiplexing signal and sets a predetermination guard interval to provide a first frequency-domain symbol and a second frequency-domain symbol. The guard interval determining unit receives the predetermination guard interval, the first frequency-domain signal, and the second frequency-domain signal to determine a phase difference between the first frequency-domain signal and the second frequency-domain signal, and determines a guard interval of the orthogonal frequency division multiplexing signal based on the phase difference.

According to an embodiment of the invention, the signal transforming unit includes a guard interval removing unit and a symbol transforming unit. The guard interval removing unit receives the orthogonal frequency division multiplexing signal and the predetermination guard interval, so as to provide a first time-domain symbol and a second time-domain symbol. The symbol transforming unit receives the first time-domain symbol and the second time-domain symbol, so as to correspondingly provide the first frequency-domain symbol and the second frequency-domain symbol.

According to an embodiment of the invention, the guard interval determining unit includes a conjugation transforming unit, a symbol rotating unit, a multiplication unit, a value totaling unit, and a guard interval deciding unit. The conjugation transforming unit receives the second frequency-domain symbol to provide a conjugated frequency-domain symbol corresponding to the second frequency-domain symbol. The symbol rotating unit receives a plurality of guard interval settings and the predetermination guard interval, so as to sequentially provide a plurality of symbol rotating parameters. The multiplication unit receives the first frequency-domain symbol and the conjugated frequency-domain symbol, and sequentially receives the symbol rotating parameters to sequentially provide a plurality of phase difference reference values respectively corresponding to the guard interval settings. The value totaling unit receives the phase difference reference values to calculate a phase difference totaling reference value respectively corresponding to the guard interval settings. The guard interval deciding unit receives the phase difference totaling reference values corresponding to the guard interval settings to determine one of the guard interval settings as the guard interval of the orthogonal frequency division multiplexing signal.

According to an embodiment of the invention, the guard interval determining unit further includes a pilot buffer for storing the second frequency-domain symbol.

A method for detecting a guard interval of an orthogonal frequency division multiplexing signal of the invention includes steps as follows. A predetermination guard interval is set. A first frequency-domain symbol and a second frequency-domain symbol are captured from the orthogonal frequency division multiplexing signal based on the predetermination guard interval. A phase difference between the first frequency-domain symbol and the second frequency-domain symbol is determined. A guard interval of the orthogonal frequency division multiplexing signal is determined based on the phase difference.

According to an embodiment, the step of capturing the first frequency-domain symbol and the second frequency-domain symbol from the orthogonal frequency division multiplexing signal based on the predetermination guard interval includes: capturing a first time-domain symbol and a second time-domain symbol from the orthogonal frequency division multiplexing signal based on the predetermination guard interval; and transforming the first time-domain symbol and the second time-domain symbol into the first frequency-domain symbol and the second frequency-domain symbol.

According to an embodiment of the invention, the first time-domain symbol and the second time-domain symbol are transformed into the first frequency-domain symbol and the second frequency-domain symbol through Fourier transformation.

According to an embodiment of the invention, the first time-domain symbol and the second time-domain symbol are time-domain symbols adjacent in time.

According to an embodiment of the invention, the step of determining the phase difference between the first frequency-domain symbol and the second frequency-domain symbol includes: sequentially providing a plurality of symbol rotating parameters respectively corresponding to a plurality of guard interval settings; and sequentially providing a plurality of phase difference reference values respectively corresponding to the guard interval settings based on the first frequency-domain symbol, the second frequency-domain symbol and the symbol rotating parameters.

According to an embodiment of the invention, the step of determining the guard interval of the orthogonal frequency division multiplexing signal based on the phase difference includes: calculating phase difference determining reference values respectively corresponding to the guard interval settings based on the phase difference reference values; and determining one of the guard interval settings as the guard interval of the orthogonal frequency division multiplexing signal based on the phase difference determining reference values corresponding to the guard interval settings.

According to an embodiment of the invention, each of the symbol rotating parameters is represented as

$${e}^{- j2π \frac{( NGIP - NGIx ) k}{N}} ,$$

wherein NGIP represents the predetermination guard interval, NGIx represents the corresponding guard interval setting, k represents a sub-carrier index, and N represents a FFT size.

According to an embodiment of the invention, the step of sequentially providing the phase difference reference values respectively corresponding to the guard interval settings based on the first frequency-domain symbol, the second frequency-domain symbol and the symbol rotating parameters includes: providing a conjugated frequency-domain symbol corresponding to the second frequency-domain symbol; and sequentially multiplexing the first frequency-domain symbol and the conjugated frequency-domain symbol with the symbol rotating parameters to sequentially provide the phase difference reference values.

According to an embodiment of the invention, the step of sequentially providing the phase difference reference values respectively corresponding to the guard interval settings based on the first frequency-domain symbol, the second frequency-domain symbol and the symbol rotating parameters includes: providing a plurality of carrier angles corresponding to the second frequency-domain symbol; and sequentially performing calculation by a plurality of carrier components of the first frequency-domain symbol, the carrier angles and the symbol rotating parameters to sequentially provide the phase difference reference values.

Based on the above, the device for detecting the orthogonal frequency division multiplexing signal and the method thereof according to the embodiments of the invention transform the first time-domain symbol and the second time-domain symbol adjacent in time into the first frequency-domain symbol and the second frequency-domain symbol, and one of the first frequency-domain symbol and second frequency-domain symbol after being rotated corresponds to the different guard interval settings. Lastly, the guard interval of the orthogonal frequency division multiplexing signal is determined based on the phase difference between the first frequency-domain symbol and second frequency-domain symbol after being rotated. In this way, inter-symbol interference and inter-carrier interference are prevented, and the guard interval of the orthogonal frequency division multiplexing signal is determined quickly and accurately.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic view illustrating a system of a device for detecting a guard interval of an orthogonal frequency division multiplexing signal according to an embodiment of the invention.

FIG. 1B is a schematic view illustrating capturing a symbol of an orthogonal frequency division multiplexing signal according to an embodiment of the invention.

FIG. 2 is a schematic view illustrating a system of a device for detecting a guard interval of an orthogonal frequency division multiplexing signal according to another embodiment of the invention.

FIG. 3 is a flowchart illustrating a method for detecting a guard interval of an orthogonal frequency division multiplexing signal according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

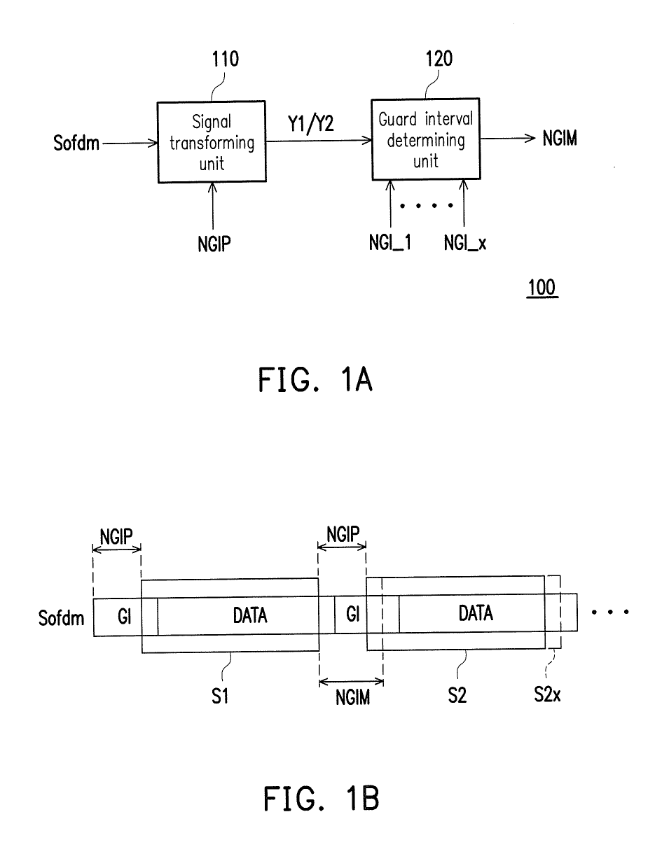

FIG. 1A is a schematic view illustrating a system of a device for detecting a guard interval of an orthogonal frequency division multiplexing signal according to an embodiment of the invention. Referring to FIG. 1A, in this embodiment, the device 100 includes a signal transforming unit 110 and a guard interval determining unit 120, for example. The signal transforming unit 110 is configured to receive an orthogonal frequency division multiplexing signal Sofdm, and receive a predetermination guard interval NGIP to set the predetermination guard interval NGIP. In addition, the predetermination guard interval NGIP is one of a plurality of guard interval settings NGI_1 to NGI_x of the orthogonal frequency division multiplexing signal Sofdm, for example, and x is a positive integer. Then, the signal transforming unit 110 provides a first frequency-domain symbol Y1 and a second frequency-domain symbol Y2 based on the orthogonal frequency division multiplexing signal Sofdm and the predetermination guard interval NGIP.

The guard interval determining unit 120 receives the predetermination guard interval NGIP, the first frequency-domain symbol Yl, the second frequency-domain symbol Y2, and the plurality of guard interval settings NGI_1 to NGI_x, so as to determine a phase difference between the first frequency-domain symbol Y1 and the second frequency-domain symbol Y2 and choose one of the guard interval settings NGI_1 to NGI_x as a guard interval NGIM of the orthogonal frequency division multiplexing symbol Sofdm based on the phase difference between the first frequency-domain symbol Y1 and the second frequency-domain symbol Y2.

FIG. 1B is a schematic view illustrating capturing a symbol of an orthogonal frequency division multiplexing signal according to an embodiment of the invention. Referring to FIGS. 1A and 1B, in this embodiment, a guard interval GI is set between symbols (i.e. data DATA of the orthogonal frequency division multiplexing signal Sofdm). The signal transforming unit 110 then sequentially captures the orthogonal frequency division multiplexing signal Sofdm based on the predetermination guard interval NGIP, so as to obtain a first time-domain symbol S1 and a second time-domain symbol S2 adjacent in time. Then, the symbol transforming unit 110 transforms the first time-domain symbol Si and the second time-domain symbol S2 into the first frequency-domain symbol Y1 and the second frequency-domain symbol Y2. In addition, the first time-domain symbol Si and the second time-domain symbol S2 may be transformed into the first frequency-domain symbol Y1 and the second frequency-domain symbol Y2 through Fourier transformation.

After obtaining the first frequency-domain symbol Y1 and the second frequency-domain symbol Y2, the signal transforming unit 110 may sequentially rotate the second frequency-domain symbol Y2, such that an interval between the second frequency-domain symbol Y2 after being rotated and the first frequency-domain symbol Y1 corresponds to the guard interval settings NGI_1 to NGI_x respectively. Then, a plurality of phase differences between the first frequency-domain symbol Y1 and the second frequency-domain symbol Y2 after being rotated are determined, and a guard interval setting (e.g. NGI_1 to NGI_x) having the lowest phase difference or having the phase difference at 0 is then set as the current guard interval NGIM of the orthogonal frequency division multiplexing signal Sofdm.

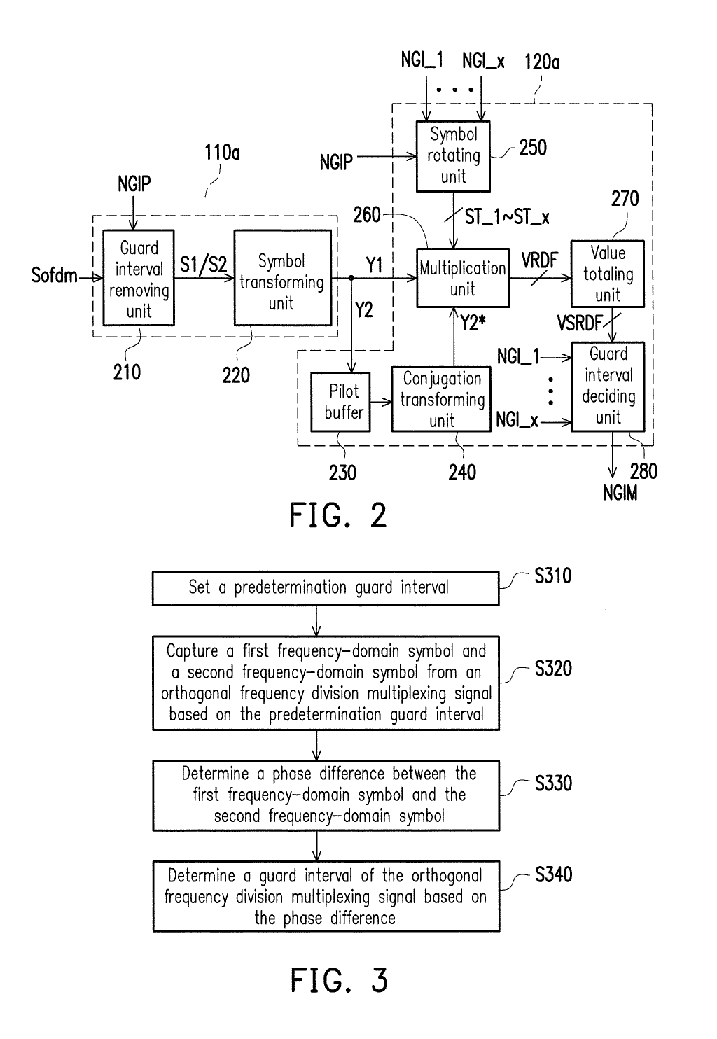

FIG. 2 is a schematic view illustrating a system of a device for detecting a guard interval of an orthogonal frequency division multiplexing signal according to another embodiment of the invention. Referring to FIGS. 1A, 1B, and 2, it should be noted that like or similar elements in the figures are referred to with like or similar reference symbols. In this embodiment, a signal transforming unit 110a includes a guard interval removing unit 210 and a symbol transforming unit 220, for example. The guard interval removing unit 210 receives the orthogonal frequency division multiplexing signal Sofdm and the predetermination guard interval NGIP, so as to provide the first time-domain symbol S1 and the second time-domain symbol S2 after removing the guard interval NGIP. The symbol transforming unit 220 receives the first time-domain symbol S1 and the second time-domain symbol S2, and then correspondingly provides the first frequency-domain symbol Y1 and the second frequency-domain symbol Y2.

In this embodiment, a guard interval determining unit 120a includes a pilot buffer 230, a conjugation transforming unit 240, a symbol rotating unit 250, a multiplication unit 260, a value totaling unit 270, and a guard interval deciding unit 280. The pilot buffer 230 is configured to store the second frequency-domain symbol Y2 to sequentially output a plurality of carrier components of the second frequency-domain symbol Y2. The conjugation transforming unit 240 receives the carrier components of the second frequency-domain Y2, performs conjugation transformation to the carrier components, and provides a conjugated frequency-domain symbol Y2* formed by a plurality of conjugated carrier components of the carrier components of the second frequency-domain symbol Y2.

The symbol rotating unit 250 receives the guard interval settings NGI_1 to NGI_x and the predetermination guard interval NGIP, so as to sequentially provide a plurality of symbol rotating parameters ST_1 to ST_x. In addition, each symbol rotating parameter (e.g. ST_1 to ST_x) is represented as

$${e}^{- j2π \frac{( NGIP - NGIx ) k}{N}} ,$$

wherein NGIP represents the predetermination guard interval, NGIx represents the guard interval setting (e.g. NGI_1 to NGI_x) corresponding to each symbol rotating parameter (e.g. ST_ 1 to ST_x), k represents a sub-carrier index, and N represents a FFT size. The multiplication unit 260 receives the first frequency-domain symbol Y1 and the conjugated frequency-domain symbol Y2*, and sequentially receives the symbol rotating parameters ST_1 to ST_x, so as to sequentially provide a plurality of phase difference reference values VRDF respectively corresponding to the guard interval settings NGI_1 to NGI_x. In addition, the symbol rotating parameters ST_1 to ST_x may be deemed as angles for rotating the second frequency-domain symbol Y2 (similar to a moved second time-interval symbol S2 shown in FIG. 1B).

To be more specifically, the phase difference reference value VRDF is equivalent to multiplication of carrier components having the same sub-carrier in the first frequency-domain symbol Y1 and the conjugated frequency-domain symbol Y2* (represented as Y1,k and Y2*,k, respectively) with the corresponding symbol rotating parameter (e.g. ST_1 to ST_x), which may be represented in a formula

$$Y 1 , k \cdot Y {2}^{⋆} , k \cdot {e}^{j2π \frac{( NGIP - NGIx ) k}{N}} .$$

Through further induction, the formula is then generalized as

$$‖ Y , k ‖ {2}^{{e}^{j2π \frac{( NGIP - NGI \_ 1 ) k}{N}} {e}^{- j2π \frac{( NGIP - NGIx ) k}{N}}} .$$

Moreover, when the interval between the second frequency-domain symbol Y2 after being rotated and the first frequency-domain symbol Y1 is different from the current guard interval NGIM of the orthogonal frequency division multiplexing signal Sofdm, a product of multiplication of

$${e}^{j2π \frac{( NGIP - NGI \_ 1 ) k}{N}} \qquad {e}^{- j2π \frac{( NGIP - NGIx ) k}{N}}$$

is 0. When the interval between the second frequency-domain symbol Y2 after being rotated and the first frequency-domain symbol Y1 is the same as the current guard interval NGIM of the orthogonal frequency division multiplexing signal Sofdm, the product of multiplication of

$${e}^{j2π \frac{( NGIP - NGI \_ 1 ) k}{N}} \qquad {e}^{- j2π \frac{( NGIP - NGIx ) k}{N}}$$

is 1. In other words,

$$‖ Y , k ‖ {2}^{{e}^{j2π \frac{( NGIP - NGI \_ 1 ) k}{N}} {e}^{- j2π \frac{( NGIP - NGIx ) k}{N}}}$$

reaches its maximum when the interval between the second frequency-domain symbol Y2 after being rotated and the first frequency-domain symbol Y1 is the same as the current guard interval NGIM of the orthogonal frequency division multiplexing signal Sofdm.

Then, the value totaling unit 270 receives the phase difference reference values VRDF to calculate phase difference totaling reference values VSRDF respectively corresponding to the guard interval settings NGI_1 to NGI_x. Then, the guard interval deciding unit 280 receives the phase difference totaling reference values VSRDF respectively corresponding to the guard interval settings NGI_1 to NGI_x, and decides with which guard interval setting (e.g. NGI_1 to NGI_x), the phase difference between the second frequency-domain symbol Y2 after being rotated and the first frequency-domain symbol Y1 is minimal or 0 accordingly. Then, the guard interval setting (e.g. NGI_1 to NGI_x) is then set as the guard interval NGIM of the orthogonal frequency division multiplexing signal.

In the above embodiments, the conjugation transforming unit 240 performs conjugation transformation to the carrier components of the second frequency-domain symbol Y2, and then provides the conjugated frequency-domain symbol Y2*. However, since it is mainly the angle of the second frequency-domain symbol Y2 and the first frequency-domain symbol Y1 that determines the value of the phase difference reference value VRDF, the conjugation transforming unit 240 thus provides the conjugated angles (i.e. providing carrier angles) of the carrier components of the second frequency-domain symbol Y2 for calculation, so as to generate the phase difference reference values VRDF, and then correspondingly provides phase difference determining reference values (e.g. the phase difference totaling reference values VSRDF) for determining the phase difference between the second frequency-domain symbol Y2 after being rotated and the first frequency-domain symbol Y1. In addition, a calculating method for generating the phase difference determining reference values may be multiplication or addition. The embodiments of the invention are not limited thereto.

FIG. 3 is a flowchart illustrating a method for detecting a guard interval of an orthogonal frequency division multiplexing signal according to an embodiment of the invention. Referring to FIG. 3, in this embodiment, the method for detecting the guard interval of the orthogonal frequency division multiplexing signal includes steps as follows. First of all, the predetermination guard interval is set (Step S310), and the first frequency-domain symbol and the second frequency-domain symbol are captured from the orthogonal frequency division multiplexing signal based on the predetermination guard interval (Step S320). Then, the phase difference between the first frequency-domain symbol and the second frequency-domain symbol are determined (Step S330), and the guard interval of the orthogonal frequency division multiplexing signal is determined based on the phase difference (Step S340). It should be noted that a sequence of Steps S310, S320, S330 and S340 are described herein only for an illustrative purpose. The embodiments of the invention are not limited thereto. In addition, details with respect to Steps S310, S320, S330 and S340 may be referred to with the description and illustration about FIGS. 1A, 1B, and 2. Therefore, no further details in this respect will be reiterated below.

In view of the foregoing, the device for detecting the orthogonal frequency division multiplexing signal and the method thereof according to the embodiments of the invention transform the first time-domain symbol and the second time-domain symbol adjacent in time into the first frequency-domain symbol and the second frequency-domain symbol, and one of the first frequency-domain symbol and second frequency-domain symbol after being rotated corresponds to the different guard interval settings. Lastly, the guard interval of the orthogonal frequency division multiplexing signal is determined based on the phase difference between the first frequency-domain symbol and second frequency-domain symbol after being rotated. In this way, inter-symbol interference and inter-carrier interference are prevented, and the guard interval of the orthogonal frequency division multiplexing signal is determined quickly and accurately.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A device for detecting a guard interval of an orthogonal frequency division multiplexing signal, comprising:
a signal transforming unit, receiving an orthogonal frequency division multiplexing signal and setting a predetermination guard interval to provide a first frequency-domain symbol and a second frequency-domain symbol; and
a guard interval determining unit, receiving the predetermination guard interval, the first frequency-domain signal, and the second frequency-domain signal to determine a phase difference between the first frequency-domain signal and the second frequency-domain signal, and determining a guard interval of the orthogonal frequency division multiplexing signal based on the phase difference.

2. The device for detecting the guard interval of the orthogonal frequency division multiplexing signal as claimed in claim 1, wherein the signal transforming unit comprises:
a guard interval removing unit, receiving the orthogonal frequency division multiplexing signal and the predetermination guard interval, so as to provide a first time-domain symbol and a second time-domain symbol; and
a symbol transforming unit, receiving the first time-domain symbol and the second time-domain symbol, so as to correspondingly provide the first frequency-domain symbol and the second frequency-domain symbol.

3. The device for detecting the guard interval of the orthogonal frequency division multiplexing signal as claimed in claim 2, wherein the symbol transforming unit transforms the first time-domain symbol and the second time-domain symbol into the first frequency-domain symbol and the second frequency-domain symbol through Fourier transformation.

4. The device for detecting the guard interval of the orthogonal frequency division multiplexing signal as claimed in claim 2, wherein the first time-domain symbol and the second time-domain symbol are time-domain symbols adjacent in time.

5. The device for detecting the guard interval of the orthogonal frequency division multiplexing signal as claimed in claim 1, wherein the guard interval determining unit comprises:
a conjugation transforming unit, receiving the second frequency-domain symbol to provide a conjugated frequency-domain symbol corresponding to the second frequency-domain symbol;
a symbol rotating unit, receiving a plurality of guard interval settings and the predetermination guard interval, so as to sequentially provide a plurality of symbol rotating parameters;
a multiplication unit, receiving the first frequency-domain symbol and the conjugated frequency-domain symbol, and sequentially receiving the symbol rotating parameters to sequentially provide a plurality of phase difference reference values respectively corresponding to the guard interval settings;
a value totaling unit, receiving the phase difference reference values to calculate a phase difference totaling reference value respectively corresponding to the guard interval settings; and
a guard interval deciding unit, receiving the phase difference totaling reference values corresponding to the guard interval settings to determine one of the guard interval settings as the guard interval of the orthogonal frequency division multiplexing signal.

6. The device for detecting the guard interval of the orthogonal frequency division multiplexing signal as claimed in claim 5, wherein the guard interval determining unit further comprises a pilot buffer for storing the second frequency-domain symbol.

7. The device for detecting the guard interval of the orthogonal frequency division multiplexing signal as claimed in claim 5, wherein each of the symbol rotating parameters is represented as
$${e}^{- j2π \frac{( NGIP - NGIx ) k}{N}} ,$$
wherein NGIP represents the predetermination guard interval, NGIx represents the corresponding guard interval setting, k represents a sub-carrier index, and N represents a FFT size.

8. A method for detecting a guard interval of an orthogonal frequency division multiplexing signal, comprising:
setting a predetermination guard interval;
capturing a first frequency-domain symbol and a second frequency-domain symbol from the orthogonal frequency division multiplexing signal based on the predetermination guard interval;
determining a phase difference between the first frequency-domain symbol and the second frequency-domain symbol; and
determining a guard interval of the orthogonal frequency division multiplexing signal based on the phase difference.

9. The method for detecting the guard interval of the orthogonal frequency division multiplexing signal as claimed in claim 8, wherein the step of capturing the first frequency-domain symbol and the second frequency-domain symbol from the orthogonal frequency division multiplexing signal based on the predetermination guard interval comprises:
capturing a first time-domain symbol and a second time-domain symbol from the orthogonal frequency division multiplexing signal based on the predetermination guard interval; and
transforming the first time-domain symbol and the second time-domain symbol into the first frequency-domain symbol and the second frequency-domain symbol.

10. The method for detecting the guard interval of the orthogonal frequency division multiplexing signal as claimed in claim 9, wherein the first time-domain symbol and the second time-domain symbol are transformed into the first frequency-domain symbol and the second frequency-domain symbol through Fourier transformation.

11. The method for detecting the guard interval of the orthogonal frequency division multiplexing signal as claimed in claim 9, wherein the first time-domain symbol and the second time-domain symbol are time-domain symbols adjacent in time.

12. The method for detecting the guard interval of the orthogonal frequency division multiplexing signal as claimed in claim 8, wherein the step of determining the phase difference between the first frequency-domain symbol and the second frequency-domain symbol comprises:
sequentially providing a plurality of symbol rotating parameters respectively corresponding to a plurality of guard interval settings; and
sequentially providing a plurality of phase difference reference values respectively corresponding to the guard interval settings based on the first frequency-domain symbol, the second frequency-domain symbol and the symbol rotating parameters.

13. The method for detecting the guard interval of the orthogonal frequency division multiplexing signal as claimed in claim 12, wherein the step of determining the guard interval of the orthogonal frequency division multiplexing signal based on the phase difference comprises:
calculating phase difference determining reference values respectively corresponding to the guard interval settings based on the phase difference reference values; and
determining one of the guard interval settings as the guard interval of the orthogonal frequency division multiplexing signal based on the phase difference determining reference values corresponding to the guard interval settings.

14. The method for detecting the guard interval of the orthogonal frequency division multiplexing signal as claimed in claim 13, wherein each of the symbol rotating parameters is represented as
$${e}^{- j2π \frac{( NGIP - NGIx ) k}{N}} ,$$
wherein NGIP represents the predetermination guard interval, NGIx represents the corresponding guard interval setting, k represents a sub-carrier index, and N represents a FFT size.

15. The method for detecting the guard interval of the orthogonal frequency division multiplexing signal as claimed in claim 12, wherein the step of sequentially providing the phase difference reference values respectively corresponding to the guard interval settings based on the first frequency-domain symbol, the second frequency-domain symbol and the symbol rotating parameters comprises:
providing a conjugated frequency-domain symbol corresponding to the second frequency-domain symbol; and
sequentially multiplexing the first frequency-domain symbol and the conjugated frequency-domain symbol with the symbol rotating parameters to sequentially provide the phase difference reference values.

16. The method for detecting the guard interval of the orthogonal frequency division multiplexing signal as claimed in claim 12, wherein the step of sequentially providing the phase difference reference values respectively corresponding to the guard interval settings based on the first frequency-domain symbol, the second frequency-domain symbol and the symbol rotating parameters comprises:
providing a plurality of carrier angles corresponding to the second frequency-domain symbol; and
sequentially performing calculation by a plurality of carrier components of the first frequency-domain symbol, the carrier angles and the symbol rotating parameters to sequentially provide the phase difference reference values.
